(19) United States
(12) Patent Application Publication
(10) Pub. No.: US 2025/0284954 A1
(43) Pub. Date: Sep. 11, 2025

(54) Method to Extract Physical Behavior Directly from Simple Visual Empirical Observation Via a Deep Learning Model

(71) Applicant: Massachusetts Institute of Technology, Cambridge, MA (US)

(72) Inventors: Markus J. Buehler, Boxford, MA (US); Andrew James Lew, Cambridge, MA (US)

(21) Appl. No.: 18/858,183

(22) PCT Filed: Feb. 21, 2023
(86) PCT No.: PCT/US2023/062924

§ 371 Date: Oct. 18, 2024

Related U.S. Application Data
(60) Provisional application No. 63/333,493, filed on Apr. 21, 2022.

(51) Int. Cl. G06N 3/08; G06N 3/0442; G06N 3/0455; G06T 5/70; G06V 20/70

(52) U.S. Cl. CPC G06N 3/08; G06N 3/0442; G06N 3/0455; G06T 5/70; G06V 20/70

(57) ABSTRACT

Buckling is a long studied mechanical process that has been tackled from a variety of theoretical and numerical methods over the past two and a half centuries. Modeling buckling behavior of complicated structures—especially new composite material(s) in an expeditious manner remains an open question, which becomes more important as architected and smart materials come into modern consideration. Despite much research, predicting buckling behavior of materials with complex structure and components, such as notched beams of non-homogeneous architected composites, remains non-trivial. The present disclosure addresses the above problem by applying artificial intelligence methods to model physical relationships directly from observational data.

### RELATED APPLICATION

This application claims the benefit of U.S. Provisional Application No. 63/333,493, filed on Apr. 21, 2022. The entire teachings of the above application(s) are incorporated herein by reference.

### GOVERNMENT SUPPORT

This invention was made with government support under FA9550-15-1-0514 awarded by the Air Force Office of Scientific Research, under W911NF-19-2-0098 awarded by the U.S. Army, and under N00014-19-1-2375 and N00014-16-1-2333 awarded by The Office of Naval Research. The government has certain rights in the invention.

### BACKGROUND

Buckling is a critical mechanical process in which a material undergoes a sudden deformation under load. The buckling process of simple beams with homogeneous materials can be solved analytically. The derivation of the critical buckling load of a column is one of the earliest engineering design formula and is still in use today. Since then, some numerical models have been manually developed to solve more complex cases of stepped non-uniform beams using Finite Element Methods (FEM) to address buckling problems without closed form solutions.

Cases of increased structural and material complexity can accordingly require increased complexity in the parameters considered and computational resources utilized. For example, when treating the mechanical properties of materials that have a cellular structure, the size of the finite elements used should be small enough such that 3-4 elements span the thickness of the cell walls. Common to existing techniques is the treatment of material properties as constants. Treating materials with multiple components, such as composites, requires knowledge of the intrinsic properties of the components, such as Young's modulus, Shear modulus, density, etc., or specific experimental characterization of the composite's holistic properties.

### SUMMARY

Buckling is a long studied mechanical process that has been tackled from a variety of theoretical and numerical methods over the past two and a half centuries. Modeling buckling behavior of complicated structures-especially new composite material(s)—in an expeditious manner remains an open question, which becomes more important as architected and smart materials come into modern consideration. Despite much research, predicting buckling behavior of materials with complex structure and components, such as notched beams of non-homogeneous architected composites, remains non-trivial.

The present disclosure addresses the above problem by applying artificial intelligence methods to model physical relationships directly from observational data. In an embodiment, the model of the present disclosure employs a Variational Autoencoder (VAE) and a Long Short-Term Memory (LSTM) network to model the buckling behavior of notched beams. The model, sometimes referred to herein as “DeepBuckle,” qualitatively and quantitatively learns known buckling behavior of homogeneous plastic beams, and has the capacity to predict novel designs that yield certain buckling behaviors with a creative, out-of-the-box implementation. Importantly, tests of the model demonstrate that the method directly generalizes to beams comprised of a more complex composite foam material, without the increased computational resources or ancillary knowledge of material characteristics required by a more traditional finite element or other continuum approaches. Notably, the method employs a simple tabletop experimental setup that can easily be transferred to other applications, for use in fundamental studies or in educational settings.

In general, Machine learning (ML) methods excel at extracting patterns from large, complex datasets. In the realm of material mechanical properties, a combination of molecular dynamics simulations, convolutional neural networks, and genetic algorithms currently can predict the fracture behaviors of 2D polycrystalline materials. In addition, a Variational Autoencoder (VAE) model with a Long Short-Term Memory (LSTM) model can predict the design space of cantilevers under compression. More generally, ML models can extract physical predictions from observational data without assuming any knowledge of the laws of physics and have begun reasoning about physical relationships like object trajectories and collisions directly from video of moving objects.

In the present disclosure, a VAE-LSTM based approach is able to directly make quantitative assessments of beam structures and predictions of temporal evolution, through generation of a simplified latent space. In doing so, the method generates a model that can understand the complexities of buckling and obtain reasonable predictions of even more complex materials without the trade-offs that complicate application of traditional methods.

In an embodiment, a method includes training a first neural network on videos of beam structures in a buckling progression to generate a two-dimensional latent space representing the beam structures, training second neural network by slicing each of videos into sliced videos and encoding each of the sliced video into the two-dimensional latent space generated by the first neural network, and generating, using the first and second neural networks, sequential latent variable values based on a frame of a beam structure input to the first and second neural networks, the sequential latent variable values enabling analysis and improvement of the beam structure.

In an embodiment, the first neural network is at least one of an autoencoder and a variational autoencoder (VAE).

In an embodiment, the second neural network is a long short term memory network.

In an embodiment, the method further includes filtering each frame of raw videos for reference colors defined to identify the beam structure from a background of the raw videos, converting each frame of the raw videos to at least one channel, removing noise from each from of the raw videos, thereby generating the videos. In an embodiment, the at least one channel is grayscale. In an embodiment, the at least one channel includes at least one of a color channel and a depth channel.

In an embodiment, the videos are provided to the first neural network unannotated with buckling progression data.

In an embodiment, the method further includes, after providing the videos to the first neural network, automatically annotating the videos with buckling progression data, the buckling progression data used in the training the first neural network.

In an embodiment, a system includes a processor and a memory with computer code instructions stored thereon. The processor and the memory, with the computer code instructions, being configured to cause the system to train a first neural network on videos of beam structures in a buckling progression to generate a two-dimensional latent space representing the beam structures, train second neural network by slicing each of the videos into sliced videos and encoding each of the sliced video into the two-dimensional latent space generated by the first neural network, and generate, using the first and second neural networks, sequential latent variable values based on a frame of a beam structure input to the first and second neural networks, the sequential latent variable values, the sequential latent variable values enabling analysis and improvement of the beam structure.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a diagram illustrating example embodiments of beam structures having defect locations in different locations.

FIG. 1B is a diagram illustrating manual compression tests for each of the defect locations with boundary conditions.

FIG. 1C is a diagram illustrating a filming setup of the compression tests.

FIG. 1D is a flow diagram illustrating a progression from raw compression experiments to a VAE that has learned a 2D latent space encoding of buckled beam structures.

FIG. 2A is a collection of diagrams illustrating the relationships between structures over the course of compression can be easily visualized within the two-dimensional latent space.

FIG. 2B are a collection of graphs that illustrate an example of latent space over time.

FIG. 2C is a graph illustrating the divergence to left or right (e.g., from columns a-o) regions of latent space that corresponds to the real space divergence of buckled structures deflecting either downward or upward over time (e.g., rows i-xiv), respectively.

FIG. 3A is a graph that illustrates distance in latent space between a compression test's initial pristine and final buckled structures has a good linear correlation to the actual magnitude of the real space beam deflection experienced by the beam.

FIG. 3B is a graph that illustrates that differentiating the trajectories of each sample (e.g., the velocity) in latent space yields traces with isolated peaks representing large structural changes within small timespans (e.g., over the timesteps).

FIGS. 4A-D are diagrams illustrating isolation of four respective samples (Case 1, Case 2, Case 3, Case 4) for clarity, one from each case of defect location, which further illustrates the relationship between latent space trajectory velocity and the morphology of beam structures.

FIG. 4E illustrates graphs of velocities in latent space along different timestep ranges for the four notch location cases.

FIG. 4F is a graph illustrating aggregation of the average times until buckling for all samples, which shows a trend relating centrality of notch location to ease of buckling.

FIG. 5 is a graph illustrating the success of the LSTM approach in predicting compression trajectories, with good agreement between an experimental progression, VAE reconstructed structure progression, and VAE-LSTM predicted structure progression.

FIG. 6A is a heatmap illustrating the amount of time elapsed before predicted buckling for each starting structure in a range of latent space points.

FIG. 6B is a heatmap that illustrates mapping of the predicted buckling values for each of these starting structures, as the distance in latent space immediately before and after predicted buckling.

FIG. 6C is a heatmap illustrating a comparison of more general buckling propensity by assigning a value proportional to the buckling value and inversely proportional to the amount of time until buckling.

FIG. 7A illustrates a generated structure with “high” buckling, a beam already in the process of deflection with only a thin connection between the left and right segments of the beam.

FIG. 7B illustrates a generated structure with “low” buckling, a straight beam with disconnected left and right halves.

FIG. 7C is diagram of a thick unnotched beam that the method can obtain a structure of, which has conventionally low buckling propensity.

FIG. 8 is a flow diagram illustrating accurately reducing bread beam structures into a 2D latent space with the VAE, demonstrating the generality of the approach to a material case in addition to the one presented in FIG. 1D.

FIG. 9A illustrates bifurcating trajectories for each notch location case over compression depending on deflection direction.

FIG. 9B is a graph that illustrates distances in latent space that linearly correlate with beam deflection magnitude.

FIG. 9C is a graph that illustrates that the LSTM model can again accurately predict latent space trajectories over the course of compression.

FIGS. 10A-C are respective diagrams illustrating beam structures that can be tested using the present disclosure.

FIG. 11 illustrates a computer network or similar digital processing environment in which embodiments of the present invention may be implemented.

FIG. 12 is a diagram of an example internal structure of a computer (e.g., client processor/device or server computers) in the computer system of FIG. 11.

### DETAILED DESCRIPTION

A description of example embodiments follows.

To train the model of the present disclosure, beam compression tests were recorded. In two different example training scenarios, different materials were used. In a first scenario, 3D printed models were built with an STL model. The geometries of the STL model were created based on images using 3D Builder (Microsoft). The resulting STL files are then sliced into g-code using a software package like Cura, and printed using an orange TPU filament in a 3D printer, such as a Fuse Deposition Molding Qidi X-Pro printer.

In a second scenario, a loaf of sliced Pepperidge Farm 100% Whole Wheat Bread was purchased from the local supermarket and used for the beam compression test. Using the templates of four initial structures having a size of 4.5 inches in length as a guide, each beam structure was carved from a separate slice of bread using a knife, such as a Daimyo Series Superior VG10 Japanese Damascus Steel Kyoku Chef's Knife. For uniformity of beam samples, the ‘heel’ slices of the bread loaf were not used.

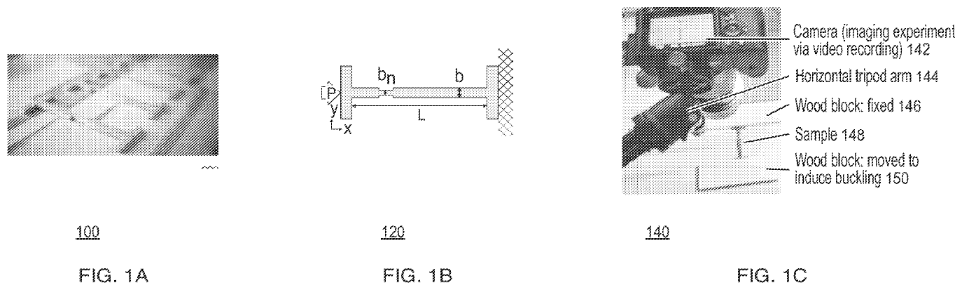

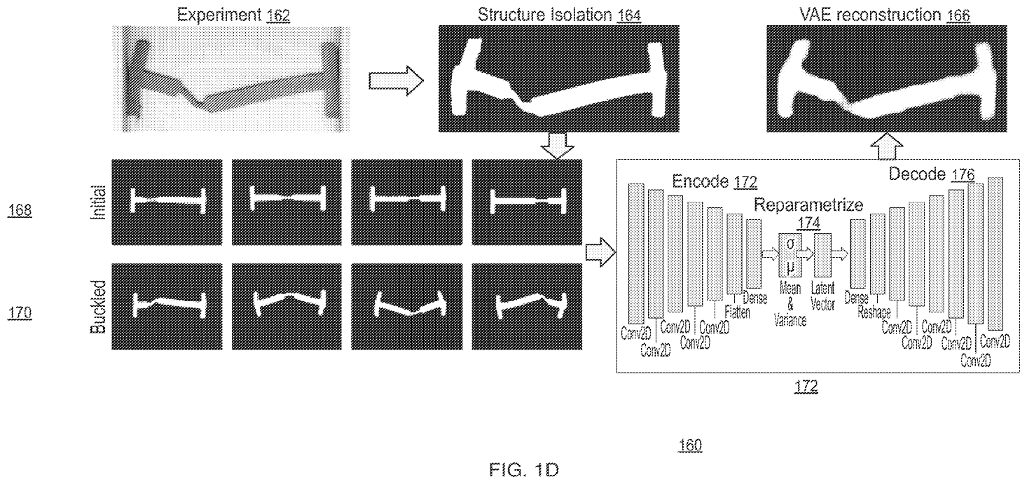

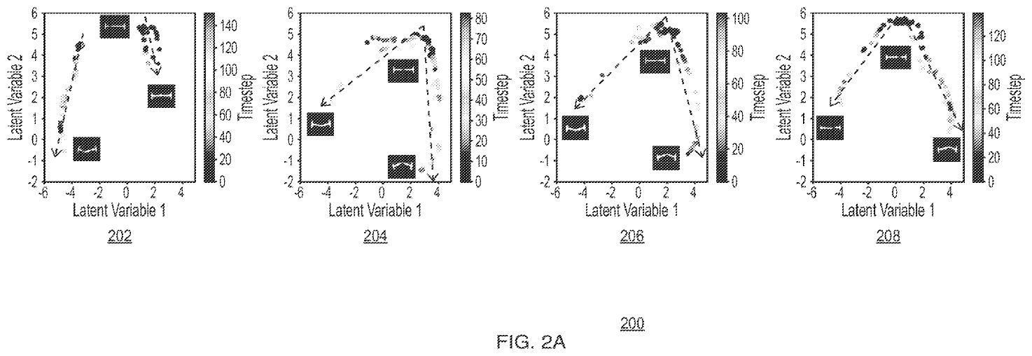

The beam compression tests of the above materials were recorded having the beam in the foreground against a neutral background for ease of sample isolation during image processing. In the first example of the TPU samples, wood was used as a background, and for the second example of the bread samples, white paper was used as the background. The right end of each beam was held fixed in place against a wall, while the left end of each beam was subject to movement in the positive x-direction, as illustrated in FIG. 1b. After placing the recording device, such as a Sony mirrorless camera or a Samsung Galaxy Note20 Ultra 5G 108 MP wide-angle camera, at an appropriate vantage point, the left wall was manually moved to conduct the compression test.

To properly train the model, image processing should be performed to allow the model to properly analyze the videos. First, reference colors are defined to identify the beam structures and differentiate those beam structures from the background (e.g., orange for the plastic beams and beige for the bread beams). Then, compression videos are, frame by frame, filtered with a mask in a range of colors around the reference color. For filtering the plastic beam(s) example, a threshold range of +/−[10, 80, 170] in hue, saturation, and value (HSV), respectively, are used. For filtering the bread beam(s) s, ranges of +/−[6, 60, 60] HSV are used for the first defect notch case, +/−[5, 50, 60] HSV for the second defect notch case, and +/−[4,40,40] HSV for the third and fourth defect notch cases, due to differences in lighting respectively. After isolating the beams from the backgrounds, the images are converted to grayscale (e.g., a single channel), passed through a bilateral filter, and converted to black and white via binary threshold. A person having ordinary skill in the art can recognize that, while the above processing converts the image to a single channel grayscale image, that multiple channels such as RGB, 3D images, or images with more than one channels can be employed. The image processing portion of the method then performs image dilation followed by erosion with a rectangular kernel of size (5,5) to remove internal noise from the identified beam structures. Finally, the method fills in small noise using a threshold contour area of 1000 to yield clean images for training.

The videos having the processed image frames described above train a VAE model to obtain a representation of the beam structures in 2-dimensional latent space. Specifically, a seven-layer encoder comprised of five convolutional layers, a flatten layer, and a dense layer is employed to obtain the latent space vector encodings. Subsequently, an 8-layer decoder comprised of a dense layer, a reshaping layer, and 6 convolutional transpose layers is employed to reconstruct the original images.

The LSTM model is comprised of two LSTM layers followed by a dense layer, hyperbolic tangent activation, and repeat vector; then two more LSTM layers, a time distributed layer, and a final linear activation. To train the LSTM model on buckling progression, the 32 buckling videos are sliced into 16000 15-frame progression segments. These segments are further split into two-frame long input sequences and 13-frame long output sequences. The structures from these images are then encoded into latent space by the VAE, to provide lists of sequential latent variable values over the compression trajectories.

For both models, the Adam optimizer, which is a method for stochastic optimization, is used with 80% of the data used for training and the remaining 20% reserved for validation. In an embodiment, the VAE is configured with a learning rate of 0.0001 and a batch size of 32, and the LSTM is configured with a default learning rate of 0.001 and batch size of 16. A person having ordinary skill in the art can recognize that other configurations of the VAE, LSTM, or other equivalent models or networks can be employed. Embodiments can be implemented in Python with the TensorFlow package.

A series of compression experiments capture a controlled range of buckling behaviors. Specifically, one experiment employed a stepped 3-segment beam wherein the central segment is of thinner width than the edge segments. Over the course of compression, this structural defect in the beam acts to localize buckling effects, allowing deliberate observation of buckling at given locations along the beam by choosing the position of this middle segment. Here, four defect locations are selected along the beam, from left to right, and samples having those defect locations are fabricated via 3D printing or other means.

FIGS. 1A-C are diagrams 110, 120, and 140 illustrating example beam structures having the defect locations described above. FIG. 1A is a diagram illustrating example embodiments of beam structures having defect locations in different locations.

FIG. 1B is a diagram illustrating manual compression tests for each of the defect locations with boundary conditions. In an embodiment, eight manual compression tests are performed on the four different defect designs. A person having ordinary skill in the art can recognize that a different number of tests can be performed on a different number of designs, and these numbers are one example embodiment. The compression test factors in the total length of the beam L, the width of the beam b, the location of the defect bn, and the force applied to the beam P.

FIG. 1C is a diagram 140 illustrating a filming setup of the compression tests. For the above described series of test, the setup produces 32 buckling videos, but a person having ordinary skill in the art can recognize that other numbers of tests can be generated. In an embodiment, each frame of each video is binarized to isolate the beam structure from the background. A person having ordinary skill in the art can recognize that other methods of isolating the beam structure can be formed, including using multiple channels to isolate the beam structure. In the setup, a camera 142 attached to a horizontal tripod arm 114 records a sample 148 between a fixed wood block 146 and a wood block 150 that induces buckling. The wood block 150 can exert the force P against the block to induce buckling that is recorded by the camera 142. The frame having the isolated beam structure is used to train a VAE that can represent images (e.g., the 256×512-pixel images) as reduced vectors in a smaller latent design space. The dimensionality of this reduced latent space can vary, but in one embodiment can be selected as a latent space dimensionality of two because this is large enough to capture sufficient information for successful reconstruction of the beam structures while being easily to visualize in a planar scatter plot.

FIG. 1D is a flow diagram 160 illustrating a progression from raw compression experiments to a VAE that has learned a 2D latent space encoding of buckled beam structures. Recorded videos of experiments 162 are transformed to a structure isolated version 164 (e.g., a black and white image isolating the structure, in some embodiments). The structure isolation 164 includes at least an initial image of an unbuckled/undamaged beam 168 and an image of the buckled beam 170, however, it should be recognized that it can also include the progression between the beams 168 and 170.

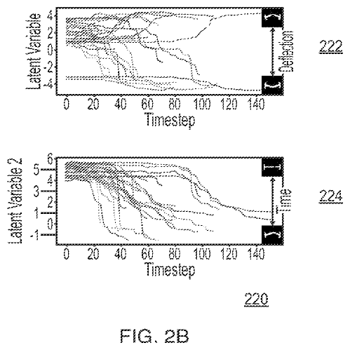

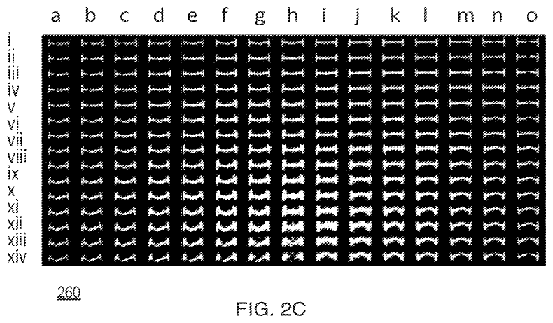

FIG. 2A is a collection 200 of diagrams 202, 204, 206, and 208 illustrating the relationships between structures over the course of compression can be easily visualized within the two-dimensional latent space. FIG. 2A illustrates these relationships, separated out by defect location case with dashed arrows labelling the progression from initial pristine to final buckled structures. Different starting defect locations translate to different starting positions in latent space.

FIG. 2B are a collection 220 of graphs 222 and 224 that illustrate an example of latent space over time. Over the course of compression, structures drift to smaller values of the second latent variable (e.g., graph 224) and divergent values of the first latent variable (e.g., graph 222).

FIG. 2C is a graph 260 illustrating the divergence to left or right (e.g., from columns a-o) regions of latent space that corresponds to the real space divergence of buckled structures deflecting either downward or upward over time (e.g., rows i-xiv), respectively. As illustrated, the structures buckle more in lower rows. The latent space learned by the VAE has regions which correspond to broken or partial beam structures despite none of these structures being presented in the training data. Purely from examples of buckling without fracture, the model extrapolates the existence of beam breakage that is known to happen in reality. Beam fracture is presented as a natural consequence of compression driven deflection, extrapolatable without any additional information.

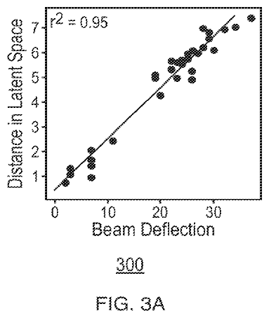

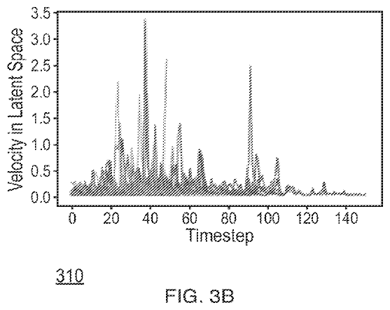

FIG. 3A is a graph 300 that illustrates distance in latent space between a compression test's initial pristine and final buckled structures has a good linear correlation to the actual magnitude of the real space beam deflection experienced by the beam with an r² value greater than 0.9. Inspecting the geometry of latent space confirms it has captured quantitative trends of buckling.

FIG. 3B is a graph 310 that illustrates that differentiating the trajectories of each sample (e.g., the velocity) in latent space yields traces with isolated peaks representing large structural changes within small timespans (e.g., over the timesteps). In other words, the method can identify the moments of buckling for each sample from the velocities of the latent space trajectories over compression.

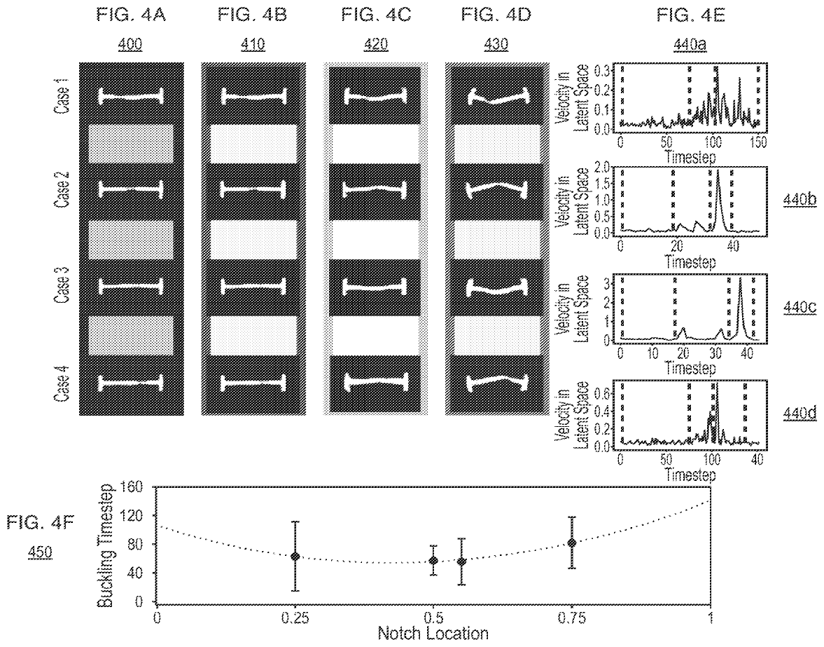

FIGS. 4A-D are diagrams 400, 410, 420, and 430 illustrating isolation of four respective samples (Case 1, Case 2, Case 3, Case 4) for clarity, one from each case of defect location, which further illustrates the relationship between latent space trajectory velocity and the morphology of beam structures. The structures FIGS. 4A and 4B are relatively similar, as demonstrated by the low constant velocities in latent space between them in graphs 440a and 440b illustrated in FIG. 4E. In contrast, FIG. 4E illustrates peaks in latent space velocity between structures the structures of FIG. 4B and FIG. 4C, such that the structure of FIG. 4C are more kinked than those of FIG. 4B. Finally, the structures illustrated by FIG. 4D show fully buckled beams after progressing past all large peaks in latent space velocity.

The structures show buckling occurs at the notch location because the presence of a notch reduces the effective local moment of the beam. The following Equations 1 and 2 describe how, at the notch location, the second moment area is reduced and thus the effective critical load before buckling is lowered.

$${P}_{cr} = \frac{{\text{?}}^{2} EI}{( KL )} \qquad ( 1 )$$

$$I = \frac{\text{?}}{\text{?}} > \frac{\text{?}}{\text{?}} , \text{?} > b \text{?} \qquad ( 2 )$$

$$\text{?} \text{indicates text missing or illegible when filed}$$

where P_{cr} is the critical load, E is the Young's modulus, K is a boundary condition dependent constant, L is the length of the beam, I is the second moment of inertia, h is the height of the beam, b is the width of the unnotched beam, and bn is the width of the beam at the notch.

FIG. 4E illustrates graphs 440a-d of velocities in latent space along different timestep ranges for the four notch location cases, with graphs 440b and 440c illustrating buckling occurring much earlier than cases one and four.

FIG. 4F is a graph 450 illustrating aggregation of the average times until buckling for all samples, which shows a trend relating centrality of notch location to ease of buckling. This trend also shows that in that the presence of a notch farther away from the end supports has a greater impact on reduction of beam load capacity.

In other words, the VAE model, once trained, has learned a latent space that identifies when and how many buckling events occur with a measure of buckling beam deflection severity, given a compression trajectory. From the VAE model, an LSTM model learns what the compression trajectories from the VAE model should be from a given starting structure.

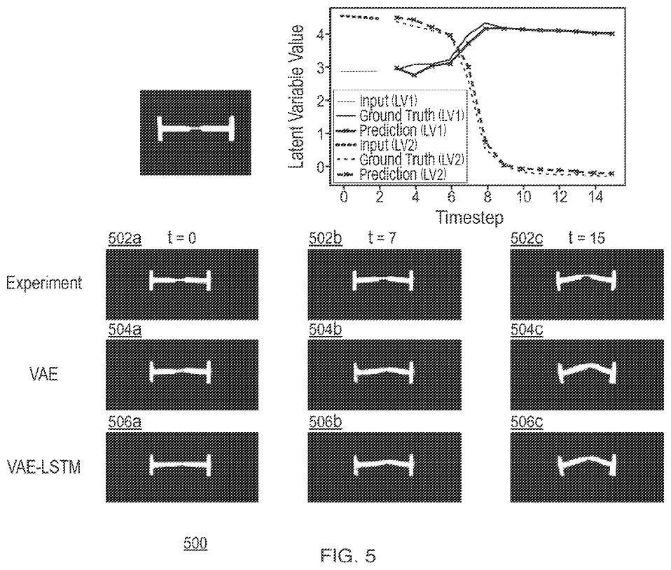

FIG. 5 is a graph 510 illustrating the success of the LSTM approach in predicting compression trajectories, with good agreement between an experimental progression 502a-c, VAE reconstructed structure progression 504a-c, and VAE-LSTM predicted structure progression 506a-c. The combined VAE-LSTM model allows predicting compression and buckling from any starting point in latent space. The model can evaluate the buckling behaviors of a variety of structures beyond the training data and identify regions in latent space more or less resilient to buckling.

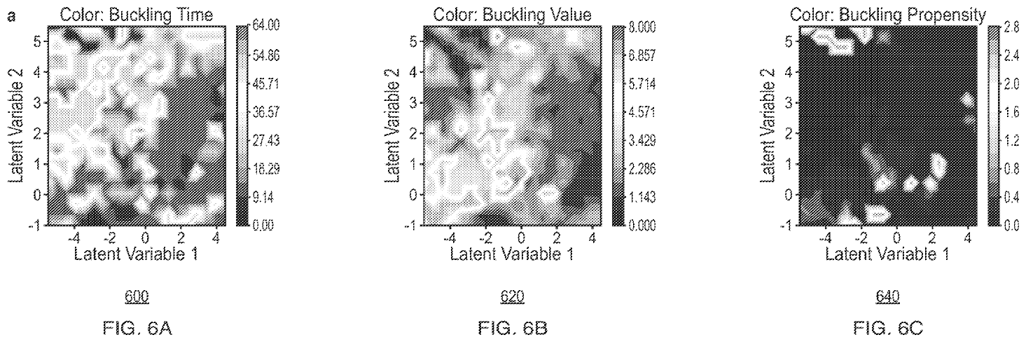

FIG. 6A is a heatmap 600 illustrating the amount of time elapsed before predicted buckling for each starting structure in a range of latent space points. FIG. 6A illustrates that some structures buckle more readily than others.

FIG. 6B is a heatmap 620 that illustrates mapping of the predicted buckling values for each of these starting structures, as the distance in latent space immediately before and after predicted buckling.

FIG. 6C is a heatmap 640 illustrating a comparison of more general buckling propensity by assigning a value proportional to the buckling value and inversely proportional to the amount of time until buckling. As illustrated by the heatmaps in the FIGS. 6A-C, some structures buckle fairly quickly but only to a small degree, while others taking a long time to buckle with a great deal of deflection.

Thus, structures predicted to have a high buckling propensity fail quickly and catastrophically, while those with a low buckling propensity take a long time to fail and only deflect mildly. By decoding the latent space points with the highest and lowest predicted buckling propensities, beam structures can be reconstructed that align with the intuition of compression behavior.

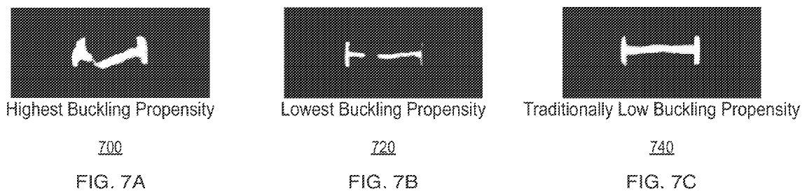

FIG. 7A illustrates a generated structure 700 with “high” buckling, a beam already in the process of deflection with only a thin connection between the left and right segments of the beam. Such a structure is on the cusp of catastrophic deflection when subject to further compression.

FIG. 7B illustrates a generated structure 720 with “low” buckling, a straight beam with disconnected left and right halves. Interestingly, the model has learned an out-of-the-box solution to minimizing buckling. Upon compression there is no deflection until the two separate ends meet, maximizing the time until buckling. Even then, the two ends need only deflect minimally to move past each other instead of in a wide connected V-shape, minimizing the buckling value magnitude. Excluding this valley in latent space, the method can obtain a structure with more conventionally low buckling propensity, a thick unnotched beam 740 such as shown in FIG. 7C.

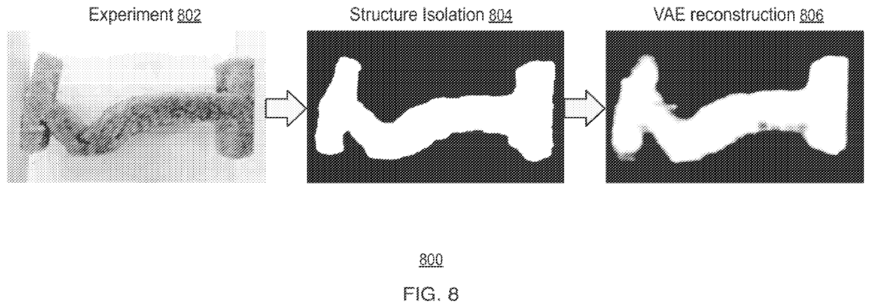

FIG. 8 is a flow diagram illustrating accurately reducing bread beam structures 802 into a 2D latent space with the VAE 804. FIG. 8 demonstrates the generality of the approach to a material case in addition to the one presented in FIG. 1D. Further, FIG. 8 illustrates prediction 806 of beam structure through this latent space.

Purely from video observation, and importantly without the need for manually inputting physics in the form of differential equations or material constants, the VAE-LSTM model approach extracts buckling behavior in line with qualitative and quantitative expectations. The method can be applied to materials of increasing complexity. And indeed, the method is shown to replicate the results using an example material with complex, nonhomogeneous hierarchical structure with various pore sizes and cell wall thicknesses that cannot be easily treated by FEM—100% whole wheat bread. After retraining both the VAE and LSTM models on the bread beam compression data, the method approaches analysis in the same manner as the homogeneous 3D printed plastic beams.

For design purposes, one must be careful in the exact context presented to the model and questions queried through it—as evidenced by the generated structure with predicted “low” buckling response in FIG. 7B that technically fulfills the requirements for minimal buckling but practically could not be used as a conventional load bearing beam. When the proper context is considered, or when dealing with questions of interpolation rather than extrapolation, the excellence of AI methods are most apparent. Future work may be done in refining the model and including extra constraints to enforce continuity of structures like of FIG. 7C, so as to avoid predictions with gaps, if this is the desired design case of interest.

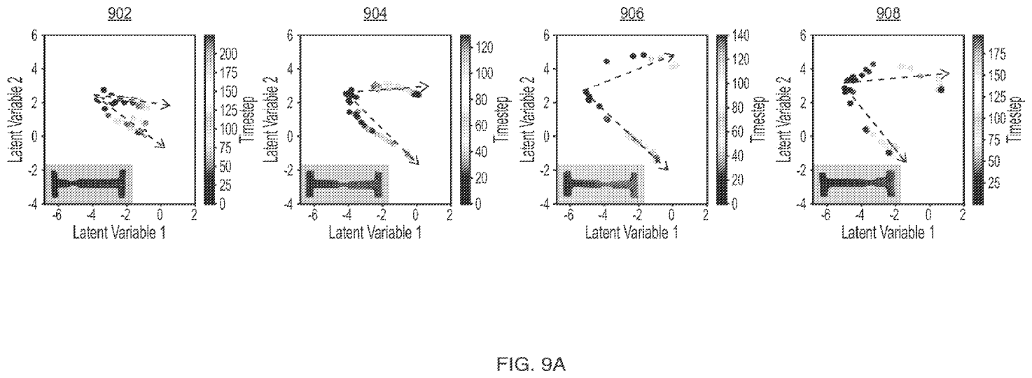

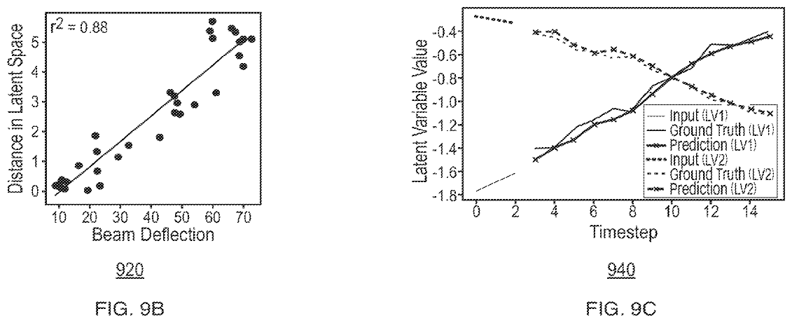

FIG. 9A illustrates bifurcating trajectories 902, 904, 906, and 908 for each notch location case over compression depending on deflection direction. FIG. 9B is a graph 920 that illustrates distances in latent space that linearly correlate with beam deflection magnitude. FIG. 9C is a graph 940 that illustrates that the LSTM model can again accurately predict latent space trajectories over the course of compression.

Regardless, a method leveraging artificial intelligence can extract physical intuition of compression and beam buckling directly from observation. While traditional FEM may work to model the homogeneous plastic material we use in our first example, the treatment of more complex materials such as foams with hierarchical structure or multiple components is not trivial. Specifically, cereal products like bread have a large porosity promoted by biochemical and thermomechanical processes, and are classified as solid foams. Furthermore, they are comprised of a blend of mainly starch and protein biopolymers and are considered as complex composites. Accurately modeling a non-standard material with both detailed structural and compositional information, such as bread, in a traditional manner expands the detail of the structural input and is difficult to accomplish, with scarce examples in the literature. Importantly, the AI-driven DeepBuckle method easily scales to such complex cases, even when based on relatively noisy manual data, with comparable prediction efficacy to standard homogeneous materials without any trade-off in increased resources or additional material information beyond observational video. The present approach may be of great value to researchers wishing to rapidly characterize and predict the buckling behavior of complex, custom materials and structures under development.

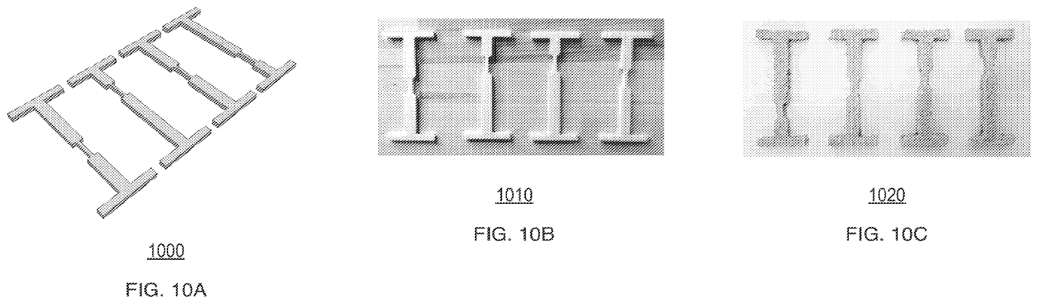

FIGS. 10A-C are respective diagrams illustrating beam structures that can be tested using the present disclosure. FIG. 10A illustrates renderings 1000 of virtual 3D models 1000 beam structures having notches/defects in different locations. FIG. 10B illustrates a photograph 1010 of 3D printed or manufactured beam structures having shape and notches/defects based on the 3D models illustrated in FIG. 10A. FIG. 10C illustrates a photograph 1020 of bread based beam structures having notches and defects to be tested using the present methods.

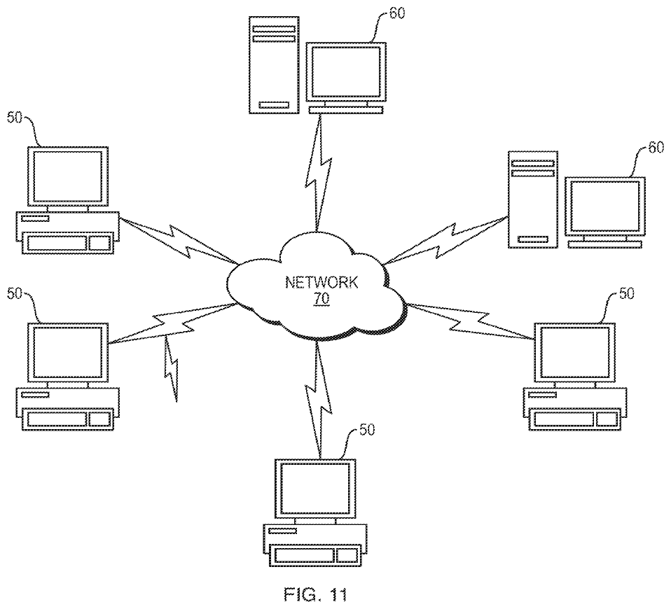

FIG. 11 illustrates a computer network or similar digital processing environment in which embodiments of the present invention may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

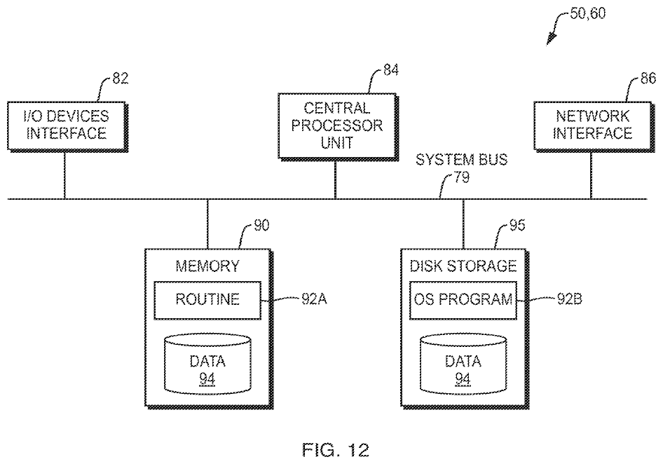

FIG. 12 is a diagram of an example internal structure of a computer (e.g., client processor/device 50 or server computers 60) in the computer system of FIG. 11. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 5). Memory 90 provides volatile storage for computer software instructions 92 and data 94 used to implement an embodiment of the present invention (e.g., image processing module, neural network and model module code detailed above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method comprising:
training a first neural network on a plurality of videos of beam structures in a buckling progression to generate a two-dimensional latent space representing the beam structures;
training second neural network by slicing each of the plurality of videos into a plurality of sliced videos and encoding each of the sliced video into the two-dimensional latent space generated by the first neural network;
generating, using the first and second neural networks, a plurality of sequential latent variable values based on a frame of a beam structure input to the first and second neural networks, the plurality of sequential latent variable values, the sequential latent variable values enabling analysis and improvement of the beam structure.

2. The method of claim 1, wherein the first neural network is at least one of an autoencoder and a variational autoencoder (VAE).

3. The method of claim 1, wherein the second neural network is a long short term memory network.

4. The method of claim 1, further comprising:
filtering each frame of a plurality of raw videos for reference colors defined to identify the beam structure from a background of the raw videos;
converting each frame of the plurality of raw videos to at least one channel;
removing noise from each from of the plurality of raw videos, thereby generating the plurality of videos.

5. The method of claim 4, wherein the at least one channel is grayscale.

6. The method of claim 4, wherein the at least one channel includes at least one of a color channel and a depth channel.

7. The method of claim 1, wherein the plurality of videos is provided to the first neural network unannotated with buckling progression data.

8. The method of claim 1, further comprising, after providing the plurality of videos to the first neural network, automatically annotating the plurality of videos with buckling progression data, the buckling progression data used in the training the first neural network.

9. A system comprising:
a processor; and
a memory with computer code instructions stored thereon, the processor and the memory, with the computer code instructions, being configured to cause the system to:
train a first neural network on a plurality of videos of beam structures in a buckling progression to generate a two-dimensional latent space representing the beam structures;
train second neural network by slicing each of the plurality of videos into a plurality of sliced videos and encoding each of the sliced video into the two-dimensional latent space generated by the first neural network; and
generate, using the first and second neural networks, a plurality of sequential latent variable values based on a frame of a beam structure input to the first and second neural networks, the plurality of sequential latent variable values, the sequential latent variable values enabling analysis and improvement of the beam structure.

10. The system of claim 9, wherein the first neural network is at least one of an autoencoder and a variational autoencoder (VAE).

11. The system of claim 9, wherein the second neural network is a long short term memory network.

12. The system of claim 9, wherein the processor is further configured to:
filter each frame of a plurality of raw videos for reference colors defined to identify the beam structure from a background of the raw videos;
convert each frame of the plurality of raw videos to at least one channel;
remove noise from each from of the plurality of raw videos, thereby generating the plurality of videos.

13. The system of claim 12, wherein the at least one channel is grayscale.

14. The system of claim 12, wherein the at least one channel includes at least one of a color channel and a depth channel.

15. The system of claim 9, wherein the plurality of videos is provided to the first neural network unannotated with buckling progression data.

16. The system of claim 9, wherein the processor is further configured to, after providing the plurality of videos to the first neural network, automatically annotate the plurality of videos with buckling progression data, the buckling progression data used in the training the first neural network.
